(19) United States
(12) Patent Application Publication
(10) Pub. No.: US 2010/0217477 A1
(43) Pub. Date: Aug. 26, 2010

(54) SPEED DEVIATION INDICATOR

(75) Inventor: Chaim BRODY, Rehovot (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Brody Engineering Ltd., Rehovot (IL)

(21) Appl. No.: 12/769,676

(22) Filed: Apr. 29, 2010

Related U.S. Application Data
(63) Continuation-in-part of application No. PCT/IB2008/054521, filed on Oct. 30, 2008.

(30) Foreign Application Priority Data
Oct. 30, 2007 (IL) 187029

(51) Int. Cl. B60Q 1/00; G06F 7/00; B23P 11/00

(52) U.S. Cl. 701/29; 340/441; 29/428

(57) ABSTRACT

Apparatus and methods for indicating speed deviations of a motor vehicle are disclosed herein. In some embodiments, upon a user engagement of a user input interface (for example, a button or dial or any other input device), a reference speed of the motor vehicle is desired. Indications of subsequent speed deviations from the reference speed are provided, for example, in a non-numerical or non-textual visual signal having a luminous intensity of at least 2000 minicandles, in a driver cone of sight defined by the motor vehicle. In some embodiments, the visual signal indicates which of three ranges of speed the driver is driving in, including too fast, too slow and a mid range.

This application is CIP of PCT/IB2008/054521 filed Oct. 30, 2008, which claims priority of IL 187029, filed Oct. 30, 2007.

### FIELD AND BACKGROUND OF THE INVENTION

The present invention relates to motor vehicles and, in particular to a speed range monitoring system.

The following published documents are believed to represent the current state of the art and the contents thereof are hereby incorporated by reference: U.S. Pat. Nos. 5,469,184; 4,229,727; 6,037,862; 5,818,332.

### SUMMARY OF THE INVENTION

The present inventor is now disclosing an apparatus and method for presenting information related to motor vehicle speed to a driver. In one example, the driver first provides a “set point speed” for example, by clicking a button (or engaging any other control), causing a prevailing vehicle speed at which the motor vehicle is traveling to be recorded. Afterwards, the subsequent vehicle speed is monitored, and an indication of how a subsequent vehicle speed deviates from the set point speed is visually presented in a ‘driver cone of sight’ defined by the vehicle to the driver. The cone of sight refers to the typical driver sitting in the vehicle's “drivers's seat” and operating the vehicle in a normal manner looking ahead at the road (see FIG. 1B).

In one non-limiting example, as long as the subsequent vehicle speed remains at the set point speed or close to the set point speed (for example, within a pre-determined tolerance or tolerances), there is no need to alert the driver of any speed deviation (or it is possible to provide some sort of “OK” status). In the event that the subsequent vehicle speed does deviate from the set point speed by more than the pre-determined tolerance speed (i.e. if the vehicle speeds up or slows down), then an indication of the speed deviation is presented to the driver.

In one particular example, a light situated in the “cone of sight” of the driver (i) adopts a first color state (for example, red) in the event that the vehicle exceeds a “maximum speed” equal to the sum of the set point speed and a pre-determined tolerance to provide a “vehicle too fast” signal, (ii) adopts a second color state (for example, no color) in the event that the vehicle speed drops below a “minimum speed” equal to the difference between the set point speed and the pre-determined tolerance to provide a “vehicle too slow” signal; and (iii) adopts a third color state (for example, green) in the event that the vehicle speed equals the driver-provided reference or setpoint within a predetermined tolerance or tolerances.

It is now disclosed for the first time a speed deviation indication apparatus for use in a motor vehicle, the apparatus comprising: a) a data input for receiving a description of a prevailing speed of the motor vehicle; b) an electronic memory for storing a non-zero reference speed and c) a user output interface operative to present, in a driver cone of sight defined by the motor vehicle, a visual signal determined a speed difference between: i) a subsequent speed of the motor vehicle as received via the data input; and ii) the established non-zero reference speed

According to some embodiments, the deviation indication apparatus further includes: d) a user input interface; and e) a controller operative to establish in accordance with a detected user engagement of the user input interface, the non-zero reference speed in accordance with a prevailing the received speed at or near a time of the user engagement.

According to some embodiments, the data input is operative to further receive a description of the non-zero reference speed (for example, via a wired or wireless interface—for example, from a sensor or from any other source).

According to some embodiments, the user output interface is configured such that the visual signal is not a numerical signal whose displayed numbers vary according to the subsequent speed.

According to some embodiments, the user output interface is configured such that the visual signal is not a textual signal whose displayed text characters vary according to the subsequent speed.

According to some embodiments, the speed deviation indicator further comprises: c) a speed categorizer, operative to categorize the subsequent speed of the motor vehicle as being in one of slow speed state, a mid speed state, and fast speed state in accordance with the speed difference between the subsequent speed and the non-zero reference speed; ii) the user output interface is operative to provide: A) a first visual signal state presented in the vehicle-defined vehicle cone of sight, when the subsequent speed is categorized in the slow speed state; B) a second visual signal state different from the first signal state, presented in the vehicle-defined vehicle cone of sight, when the subsequent speed is categorized in the mid speed state; and C) a third visual signal state different from the first and second visual signal states, presented in the vehicle-defined vehicle cone of sight, when the subsequent speed is categorized in the fast speed state; iii) the speed categorizer is operative to: i) decide if the subsequent speed is categorizable as in the slow speed state or in the mid speed state in accordance with a difference between the non-zero reference speed and a first non-zero tolerance; and ii) decide if the subsequent speed is categorizable as in the mid speed state or in the fast speed state in accordance with a sum of the non-zero reference speed and a second non-zero tolerance.

According to some embodiments, the first and second non-zero tolerances are equal.

According to some embodiments, at least one of a first and second conditions are true: i) according to the first condition, one or both of a slow-mid transition and a mid-slow transition speed are equal to the difference between the non-zero reference speed and the first non-zero tolerance; and ii) according to the second condition, one or both of a mid-fast transition speed and a fast-mid transition speed are equal to the sum of the non-zero reference speed and the second non-zero tolerance.

According to some embodiments, both the first and second conditions are true.

According to some embodiments, the speed categorizer is operative to categorize the subsequent speed of the motor vehicle in accordance with both a current value and one or more historical values of the difference between the subsequent speed and the established non-zero reference speed.

According to some embodiments, the speed categorizer is operative to categorize the subsequent speed in accordance with both: i) a current value of the difference; ii) a most recent speed transition type.

According to some embodiments, the speed categorizer is operative such that a mid-fast transition speed exceeds a fast-mid transition speed.

According to some embodiments, the speed categorizer is operative such that a slow-mid transition speed exceeds a mid-slow transition speed.

According to some embodiments, the first and second tolerance values are relative tolerance values.

According to some embodiments, the first and second tolerance values are absolute tolerance values.

According to some embodiments, the user output interface is operative such that the providing of the first, second and third visual signal states include: (i) providing, in the vehicle-defined vehicle cone of sight, a first blink pattern for the first visual signal when the subsequent speed is categorized in the slow speed state; (ii) providing, in the vehicle-defined vehicle cone of sight, a second blink pattern different from the first blink pattern for the second visual signal when the subsequent speed is categorized in the mid-speed state; and (iii) providing, in the vehicle-defined vehicle cone of sight, a third blink pattern different from the first and second blink patterns for the third visual signal when the when the subsequent speed is categorized in the fast-speed state; wherein: A) for the first and second blink patterns, a blink frequency ratio between a faster of the first and second blink patterns and a slower of the first and second blink patterns is at least 10; B) for the first and third blink patterns, a blink frequency ratio between a faster of the first and third blink patterns and a slower of the first and third blink patterns is at least 10; c) for the second and third blink patterns, a blink frequency ratio between a faster of the second and third blink patterns and a slower of the second and third blink patterns is at least 10; and d) at least one of the first, second and third blink patterns has a frequency that is at least 0.1 Hz and at most 10 Hz.

According to some embodiments, the user output interface is operative such that the providing of the first, second and third visual signal states include: i) providing, in the vehicle-defined vehicle cone of sight, a first color signal for the first visual signal when the subsequent speed is categorized in the slow speed state; ii) providing, in the vehicle-defined vehicle cone of sight, a second color signal different from the first color signal for the second visual signal when the subsequent speed is categorized in the mid-speed state; and iii) providing, in the vehicle-defined vehicle cone of sight, a third color signal different from the first and second color signals for the third visual signal when the when the subsequent speed is categorized in the fast-speed state.

According to some embodiments, the apparatus further includes: d) the motor vehicle, wherein the user input interface is deployed in front of a driver seat of the motor vehicle.

According to some embodiments, the apparatus further includes: d) the motor vehicle, wherein the user input interface is deployed in a front third of a cabin of the motor vehicle.

It is now disclosed for the first time a method of manufacturing comprising: a) deploying in a motor vehicle: i) a data input for receiving a description of a prevailing speed of the motor vehicle; ii) a user input interface for establishing, in accordance with a user engagement of the user input interface, a non-zero reference speed determined by a prevailing the received prevailing speed at or near a time of the user engagement; and iii) a user output interface operative to present, in a driver cone of sight defined by the motor vehicle, a visual signal determined a speed difference between: A) a subsequent speed of the motor vehicle as received via the data input; and B) the established non-zero reference speed

It is now disclosed for the first time a method of signaling motor vehicle speed deviation, the method comprising: a) establishing a non-zero reference speed; b) receiving a description of a prevailing speed of a motor vehicle; and c) presenting, in a driver cone of sight defined by the motor vehicle, a visual signal determined a speed difference between: i) a subsequent speed of the motor vehicle as received via the data input; and ii) the established non-zero reference speed.

According to some embodiments, the establishing of the non-zero reference speed is carried out: i) in response to a detected user engagement of a user input interface; ii) in accordance with a prevailing the speed of the motor vehicle at or near a time of the user engagement.

According to some embodiments, the establishing of the non-zero reference speed is carried out in accordance with non-user data.

According to some embodiments, the establishing of the non-zero reference speed is carried out in accordance with a communication received wirelessly.

According to some embodiments, the presenting is carried out using a user output interface deployed in front of a driver seat of the motor vehicle.

According to some embodiments, the presenting is carried out using a user output interface deployed in a front third of the motor vehicle.

According to some embodiments, the visual signal is not a numerical signal whose displayed numbers vary according to the subsequent speed.

According to some embodiments, the visual signal is not a textual signal whose displayed text characters vary according to the subsequent speed

According to some embodiments, the method further includes: d) categorizing the subsequent speed of the motor vehicle as being in one of slow speed state, a mid speed state, and fast speed state in accordance with the speed difference between the subsequent speed and the non-zero reference speed; wherein i) the presenting of the visual signal includes providing: A) a first visual signal state presented in the vehicle-defined vehicle cone of sight, when the subsequent speed is categorized in the slow speed state; B) a second visual signal state different from the first signal state, presented in the vehicle-defined vehicle cone of sight, when the subsequent speed is categorized in the mid speed state; and C) a third visual signal state different from the first and second visual signal states, presented in the vehicle-defined vehicle cone of sight, when the subsequent speed is categorized in the fast speed state; and ii) the categorizing of the subsequent speed includes: A) deciding if the subsequent speed is categorizable as in the slow speed state or in the mid speed state in accordance with a difference between the non-zero reference speed and a first non-zero tolerance; and B) deciding if the subsequent speed is categorizable as in the mid speed state or in the fast speed state in accordance with a sum of the non-zero reference speed and a second non-zero tolerance.

According to some embodiments, the first and second non-zero tolerances are equal.

According to some embodiments, for the categorizing, at least one of a first and second conditions are true: i) according to the first condition, one or both of a slow-mid transition and a mid-slow transition speed are equal to the difference between the non-zero reference speed and the first non-zero tolerance; and ii) according to the second condition, one or both of a mid-fast transition speed and a fast-mid transition speed are equal to the sum of the non-zero reference speed and the second non-zero tolerance.

According to some embodiments, both the first and second conditions are true.

According to some embodiments, the categorizing of the subsequent speed of the motor vehicle is carried out in accordance with both a current value and one or more historical values of the difference between the subsequent speed and the established non-zero reference speed.

According to some embodiments, the categorizing of the subsequent speed of the motor vehicle is carried out in accordance with both: i) a current value of the difference; ii) a most recent speed transition type.

According to some embodiments, the categorizing of the subsequent speed of the motor vehicle is carried out such that a mid-fast transition speed exceeds a mid-slow transition speed.

According to some embodiments, the categorizing of the subsequent speed of the motor vehicle is carried out such that a slow-mid transition speed exceeds a mid-slow transition speed.

According to some embodiments, the first and second tolerance values are relative tolerance values.

According to some embodiments, the first and second tolerance values are absolute tolerance values.

According to some embodiments, the providing of the first, second and third visual states includes: i) providing, in the vehicle-defined vehicle cone of sight, a first blink pattern for the first visual signal when the subsequent speed is categorized in the slow speed state; ii) providing, in the vehicle-defined vehicle cone of sight, a second blink pattern different from the first blink pattern for the second visual signal when the subsequent speed is categorized in the mid-speed state; and iii) providing, in the vehicle-defined vehicle cone of sight, a third blink pattern different from the first and second blink patterns for the third visual signal when the when the subsequent speed is categorized in the fast-speed state; wherein: A) for the first and second blink patterns, a blink frequency ratio between a faster of the first and second blink patterns and a slower of the first and second blink patterns is at least 10; B) for the first and third blink patterns, a blink frequency ratio between a faster of the first and third blink patterns and a slower of the first and third blink patterns is at least 10; C) for the second and third blink patterns, a blink frequency ratio between a faster of the second and third blink patterns and a slower of the second and third blink patterns is at least 10; and D) at least one of the first, second and third blink patterns has a frequency that is at least 0.1 Hz and at most 10 Hz.

According to some embodiments, the providing of the first, second and third visual states includes: i) providing, in the vehicle-defined vehicle cone of sight, a first color signal for the first visual signal when the subsequent speed is categorized in the slow speed state; ii) providing, in the vehicle-defined vehicle cone of sight, a second color signal different from the first color signal for the second visual signal when the subsequent speed is categorized in the mid-speed state; and iii) providing, in the vehicle-defined vehicle cone of sight, a third color signal different from the first and second color signals for the third visual signal when the when the subsequent speed is categorized in the fast-speed state.

### BRIEF DESCRIPTION OF THE DRAWINGS

The invention is herein described, by way of example only, with reference to the accompanying drawings, wherein:

FIG. 1A and FIG. 1B provide illustrations of an exemplary apparatus for providing a user with an indication of a speed deviation as deployed in the cockpit of a motor vehicle.

FIG. 1C is a schematic illustrating an exemplary driver cone of sight in an exemplary vehicle

FIG. 2A-2B provide flowcharts depicting routines for receiving set-point speed data and presenting a speed deviation indication in accordance with some embodiments of the present invention.

FIGS. 2C-2D provide descriptions of exemplary speed transition speeds.

FIG. 3A-3B provides a block diagram of an apparatus for displaying speed deviation information indication in accordance with some embodiments of the present invention.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to”), rather than the mandatory sense (i.e. meaning “must”).

### DESCRIPTION OF THE PREFERRED EMBODIMENTS

The present invention will now be described in terms of specific, example embodiments. It is to be understood that the invention is not limited to the example embodiments disclosed. It should also be understood that not every feature of the presently disclosed method, device and system for presenting vehicle speed deviation information is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The present inventor is now disclosing an apparatus and a technique for providing a driver of a motor vehicle with a color parameter depicting a deviation from a user established “target” or “safe” speed.

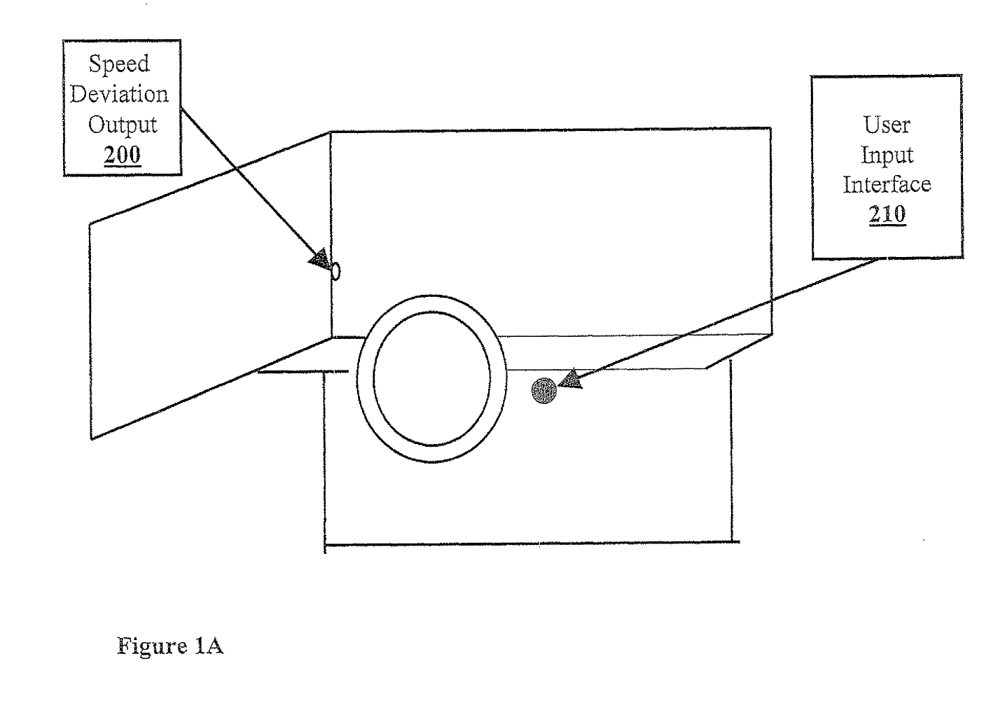

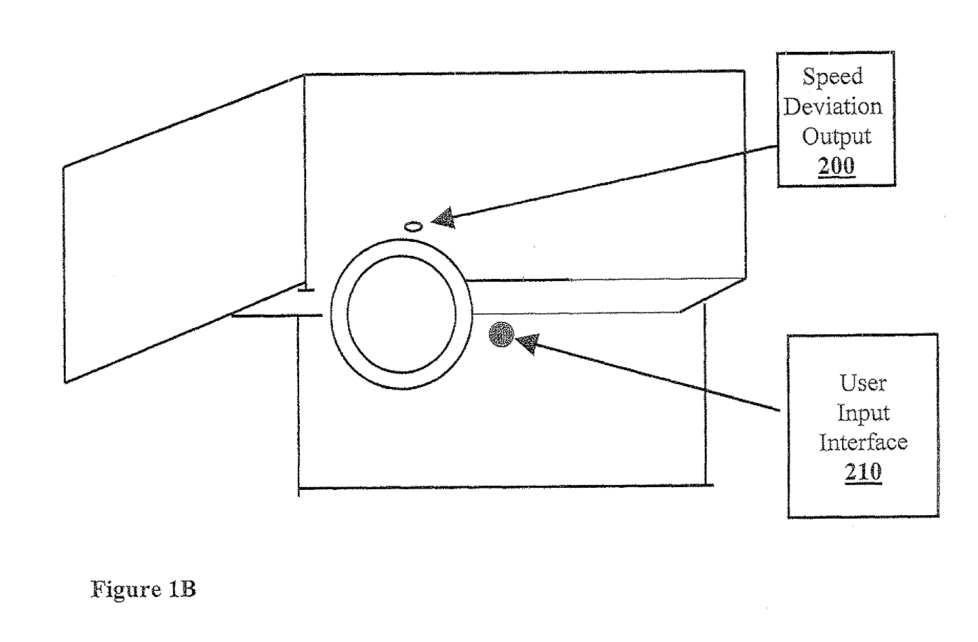

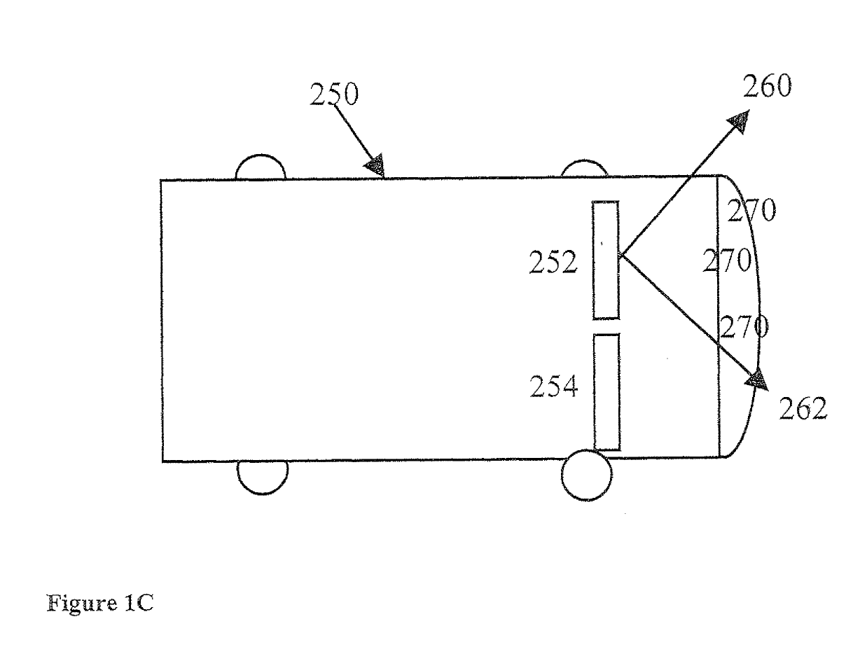

FIG. 1 provides an illustration of an exemplary apparatus for providing a user with in indication a speed deviation as deployed in the cockpit of a motor vehicle. In the example of FIG. 1, the apparatus includes an input interface 210 including a user control (for example a button or knob) for receiving a user directive to establish a “set-point” speed—in one example, the set point speed is the prevailing speed of the motor vehicle at the time the user depresses the button, turns the knob, or engages and other control.

The exemplary apparatus of FIG. 1 also includes a speed deviation output 200 for indicating to the driver if a subsequent speed deviates from the set point speed, for example, if the subsequent speed deviates from the set point speed by an amount greater than a pre-determined “speed tolerance.” In one example, the speed deviation output 200 includes one or more lights configured to provide a “color signal” to the driver.

Thus, according to this example, the speed deviation output 200 may adopt a first color state (for example, red) in the event that the vehicle exceeds a “maximum speed” equal to the sum of the set point speed and a pre-determined tolerance to provide a “vehicle too fast” signal, (ii) adopt a second color state (for example, no color) in the event that the vehicle speed drops below a “minimum speed” equal to the difference between the set point speed and the pre-determined tolerance to provide a “vehicle too slow” signal; and (iii) adopt a third color state (for example, green) in the event that the vehicle speed equals the reference speed Sr, within one or more speed tolerances In the present disclosure, this is referred to as the “mid-speed” color state.

In yet another example, rather than providing lights in of 3 different colors (or in addition to providing this features), three “blinking states” are provided—for the “mid-speed” state 25 a first blinking state (for example, a steady signal), for the “over-speed” state 30 a blinking light, for the “under-speed” state 45 the light may be off.

The exemplary apparatus of FIG. 1 also includes electronic circuitry (not shown).

In the example of FIG. 1, the speed deviation output 200 is deployed in a cone of sight of the driver but does not obstruct the driver's front view.

FIG. 1C provides an illustration of an exemplary driver cone of sight (the region labeled as 270) defined by an exemplary motor vehicle 250. In the example of FIG. 1B, the driver sits on driver-site seat 252, and can see objects in the “driver cone of sight” 270.

It is advantageous to place the indicator in the “cone of sight” 270 (i.e. in the driver's normal field of vision when driving) because this allows the driver to see the visual indication without “taking his eyes off the road.”

As shown in FIG. 1B, the cone of sight is defined as the field of vision of a typical driver when the driver is sitting in the “driver's seat” to operative the motor vehicle and looking at the road ahead.

In some embodiments, the output user interface 200 for indicating the speed deviation is deployed in the front portion of the vehicle cockpit (for example, in the front third, quarter, or sixth of the vehicle cockpit). Alternatively or additionally, the output user interface 200 is deployed on the windshield of the vehicle or infront of the vehicle 250, in the ‘cone of sight’.

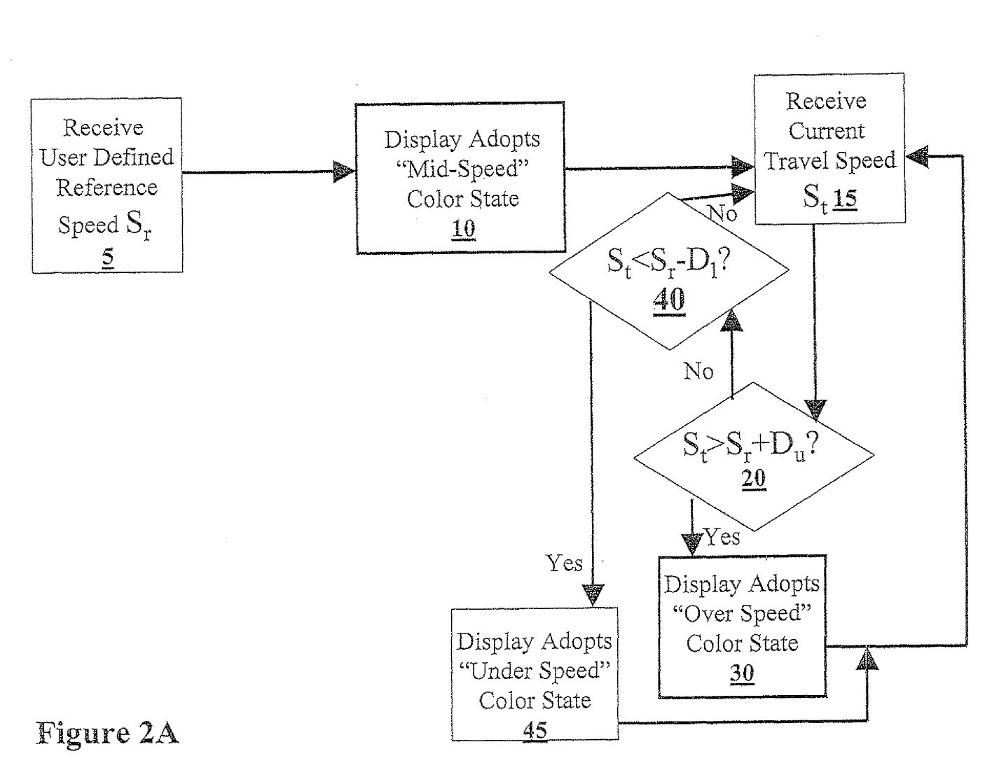

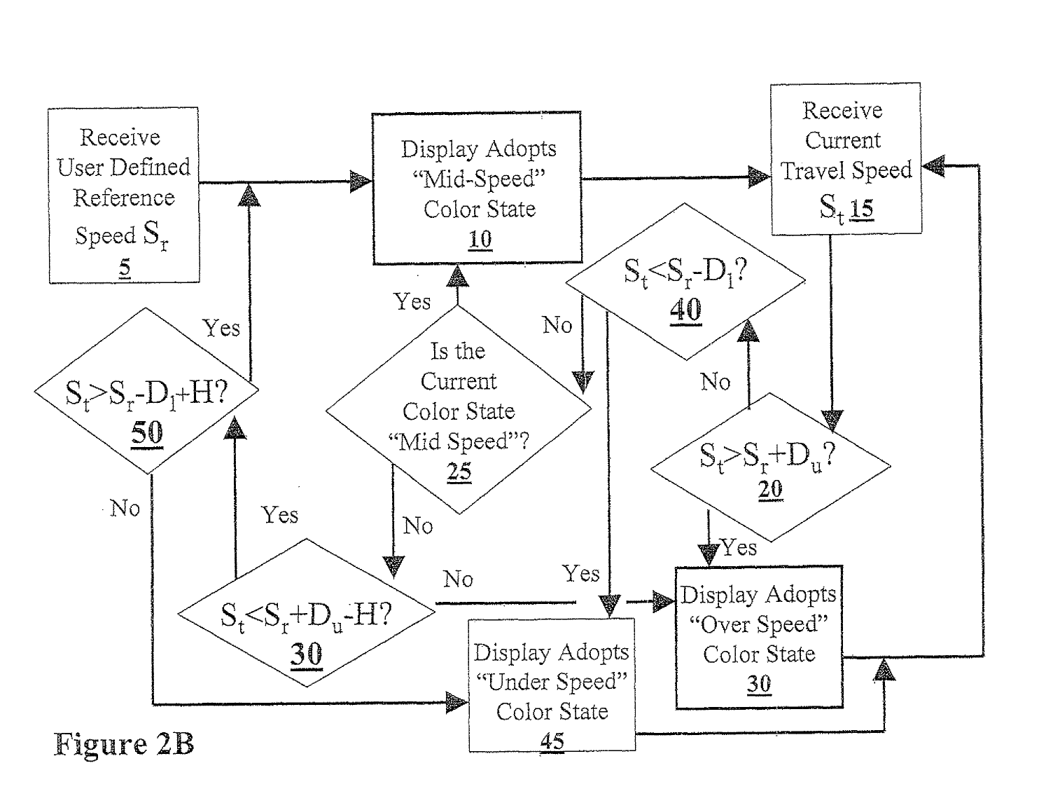

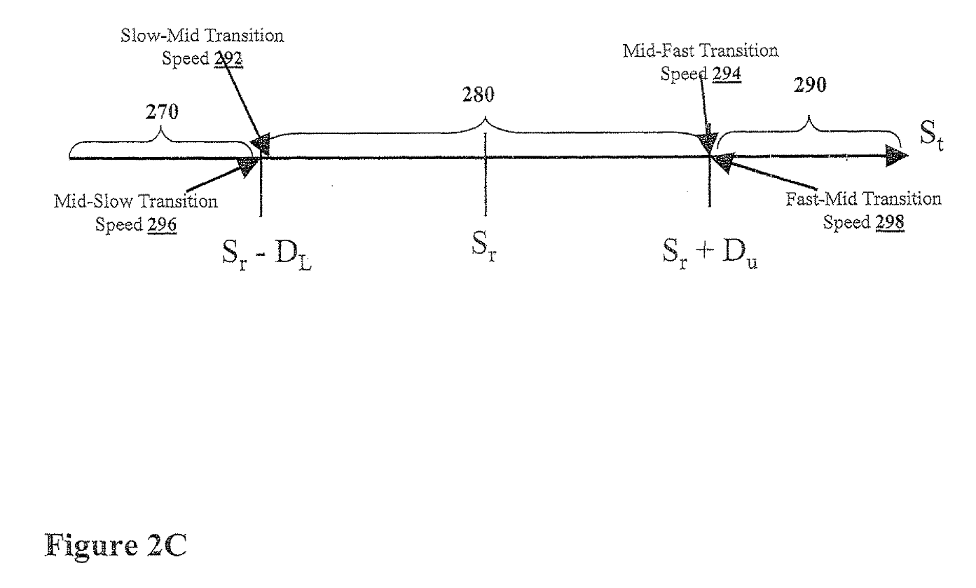

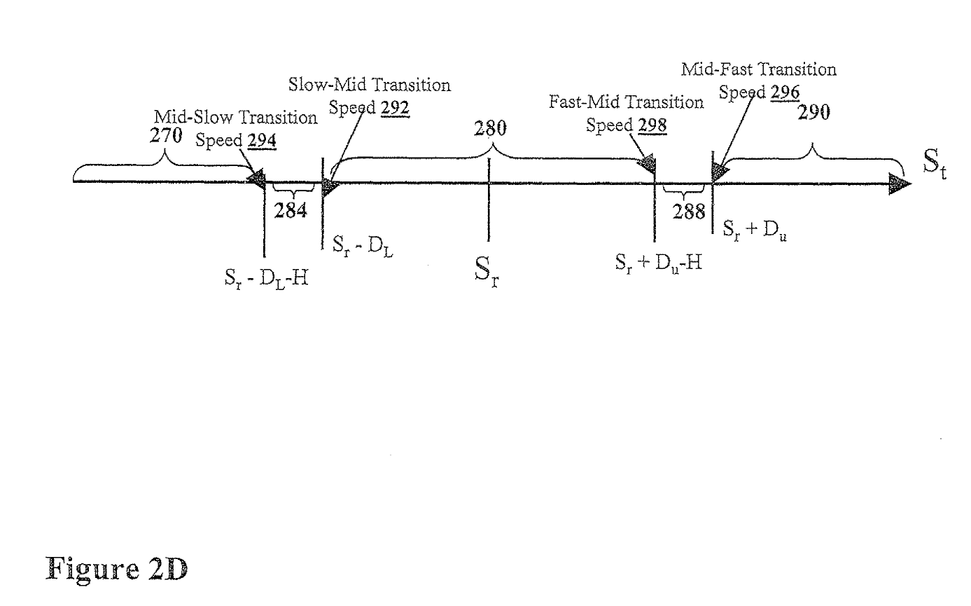

FIG. 2A provides a flowchart depicting a routine for receiving set-point peed data and presenting a speed deviation indication in accordance with some embodiments of the present invention. In the description of FIG. 2A, we will use the following definitions:
Reference speed (Sr)-This is the value the of a chosen travel speed in step 5. In one example, this value is chosen by the user by activating a button or other portion of a “user input interface.” Alternatively or additionally, in another example, this value may be received from (i) an external wireless signal (for example, in accordance with a local speed limit) and/or (ii) an internal instrument which may monitored, for example, safety conditions and/or lighting and/or fuel economy or anything else. The value of 40 miles per hour will be used in our examples.
Deviation values, (upper and lower Du & Dl)-These values define the degree of departure allowed from the reference speed (Sr) in order to provide a “deviation” signal. In one example they are preset so that they are not modifiable by a user, though this should certainly not be construed as a limitation. In one example, Dᵤ Dₗ, though this is not a limitation. We will use 5 miles per hour for both the upper and lower deviations throughout our examples.
“Mid speed” color status-This is the color the user output adopts when the vehicle speed is equal to or “almost” equal (i.e. as defined by the upper and lower deviation values (Du & Dl)) to the set point values. Blue will be used throughout the examples, though it is appreciated that this is not a limitation
“Over speed” color status—This is the color the user output adopts when the speed exceeds the upper deviation (Du). Red will be used throughout the examples, though it is appreciated that this is not a limitation.
“Under speed” color status-This is the color the user output adopts when the speed falls below the lower deviation limit (Dl). “No color” throughout the examples though it is appreciated that this is not a limitation, and in some examples, a color may be provided.

According to the example of FIG. 2A, a user defined reference speed is first received 5—for example, by electronically recording a prevailing vehicle speed at or near a time that input interface 210 is engaged. This represents the “set-point” or “driver-desired” vehicle speed. In exemplary embodiments, “near” the time of that the input interface 210 is engaged refers, for example, to within 20 seconds, or within 10 seconds or within a few seconds or within one second of when input interface 210 is engaged.

In another example, the reference or “set-point” speed can be provided by an outside wireless signal, and received “externally” rather than from the user or driver.

In one example, upon receiving the user-defined reference speed 5, it may be said that an “active mode” has been established and subsequent speeds of the motor vehicle will be monitored. In accordance with deviations between the monitored subsequent speed of the motor vehicle and the setpoint or reference speed, a visual indication will be presented to the driver.

Alternatively, the “active mode” may start with the ignition switch, with a default set point being pre-programmed, for example, a known urban speed limit.

In the example of FIG. 2A, at the time the “set point” speed is established, the vehicle, by definition, is traveling at the “desired” or “target” speed or in the “mid-speed” range. Thus, as indicated in step 10, speed deviation 3 output 200 adopts the “mid-speed” color state—for example, by providing a specific color or no color or no illumination.

In step 15, a prevailing speed of the vehicle is received (i.e. the prevailing speed at a time subsequent to the receiving of the reference speed in step 5). The prevailing speed may be received from any “speedometer” (i.e. apparatus for measuring the speed of the vehicle), including but not limited to a mechanical speedometer, a VSS (vehicle speed sensor) built-in sensors, GPS or any other apparatus for detecting vehicle speed.

In the event that the subsequent vehicle speed exceeds 20 the setpoint or reference speed by a predetermined “upper” tolerance Dᵤ (for example, as determined by “comparator” electronic circuitry), the speed deviation output 200 or display adopt the “over speed color state 30”—for example, emitting a red color.

In the event that the subsequent vehicle speed drops below 40 the setpoint or reference speed by a predetermined “lower” tolerance Dₗ (for example, as determined by “comparator” electronic circuitry), the speed deviation output 200 or display adopts the “under speed color state 30”—for example, emitting a blue color.

The present inventor notes that there may be some situations where the speed deviation indicator 200 could “flicker” or “jitter” between two states if the speed of the vehicle increases and decreases at a high frequency. For example, if the reference speed Sr is set to 40 miles an hour and Du is 5 miles an hour, it is possible that subsequently, the speed of the vehicle could oscillate between 44 miles an hour and 46 miles an hour. In this situation, it is possible that the speed deviation indicator 200 could “flicker” or “jitter” between two the “mid speed” color state and the “over speed” color state, and this may inconvenience the driver.

FIG. 2B provides a flowchart depicting a modified routine for receiving set-point peed data and presenting a speed deviation indication in accordance with some embodiments of the present invention. According to the modification, the speed deviation indication is provided in accordance with a Hystereses value (H)—this parameter prevents the display from flickering between colors when the speed vacillates between a “mid speed” range and non-“mid speed” range. In the examples below, 2 miles per hour will be used the hystereses value.

Thus, in one example: (i) in order for the speed indicator to transition from the “mid speed” color state to the “over speed” color state, the speed must exceed the sum of the set point speed Sr and the upper tolerance speed Du; (ii) in order for the sped indicator to return back to the “mid speed” color state (i.e. to transition back from the “over speed” color state to the “mid speed” color state), it is not sufficient for the vehicle speed to drop back below the sum of the set point speed. Sr and the upper tolerance speed Du. Instead, the vehicle speed must drop by an additional amount equal to the hysteres value H. Not wishing to be bound by theory, this may be useful for reducing any type of “flicker” effect.

Thus, as shown in the figures, if (i) the vehicle speed does not exceed 20 the set point speed by the upper tolerance value; (ii) the vehicle exceed is not below 40 the set point minus by the lower tolerance value, it is not a requirement (as is the case for the routine of FIG. 2A) that the color state is mid speed.

Instead, one or more of the conditions of 30 and 50 are enforced. According to the condition of 30 (relevant only when the current color state is not 25 mid speed), the speed must drop by an additional amount equal to the hysteres value H in order for the speed deviation indicator 200 to transition back from the “over speed state” to the “mid speed state.”

The condition of step 50 refers to the case where the speed has dropped below the Sr-Dl threshold, and then increases about the Sr-Dl threshold. According to the condition of step 50, the speed must increase by an additional amount equal to the hysteris value H in order for the speed deviation indicator 200 to transition back from the “under speed state” to the “mid speed state.”

To illustrate how the invention reacts to different travel speeds, we will examine different stages of the system response to three, consecutive but different travel speeds. An explanation of each of the pertinent variables and their assumed values are as follows:

### EXAMPLE 1

### St=42 Miles Per Hour

After the system receives 5 a reference speed (Sr), the output display adopts 10 a “mid-speed color”, blue, and receives 15 a current travel speed (St). The system compares 20 the current travel speed (St) to the sum of the reference speed (Sr) and the upper deviation value (Du). Since the travel speed, 42 m.p.h., does not exceed the sum of the reference speed, 40 m.p.h., and the upper deviation value, 5 m.p.h., the system makes a second comparison 40, between the travel speed (St) and the difference between the reference speed (Sr) and the lower deviation value (Dl). The current travel speed, which is not less than the difference between the reference speed, and the deviation value, implies the travel speed falls within the “mid speed” range. In our case the current travel speed, 42 m.p.h. is not less than 40-35=35 m.p.h. The system evaluates if the hystereses value should be incorporated into the calculation. As noted above, the hystereses value is a delay parameter that prevents the display from flickering between the “mid speed” color status and a non-“mid speed” color status. Therefore the hystereses value is an issue only when the display has previously adopted a non-“mid speed” color status and is in the process of displaying the “mid speed” color status. The system makes the hystereses evaluation 25 by querying if the current color state is the “mid speed” status. In our example, the travel speed, 42 m.p.h., has been determined to fall within the “mid speed” range and the display is currently in the “mid speed” color status, so the display maintains 10 a “mid speed” color status. The system then receives 15 a new travel speed (St) and repeats the comparison functions

### EXAMPLE 2

### St=46 Miles Per Hour

After the system receives 15 a new current travel speed (St) the system compares 20 the current travel speed (St) to the sum of the reference speed (Sr) and the upper deviation value (Du). Since the travel speed, 46 m.p.h., exceeds the sum of the reference speed, 40 m.p.h., and the upper deviation value, 5 m.p.h., the system display adopts 30 the “over speed” color status. The system then receives 15 a new travel speed (St) and repeats the comparison functions.

### EXAMPLE 3

### St=44 Miles Per Hour

After the system the system display adopts 30 the “over speed” color status, the system then receives 15 a new current travel speed (St). As above, the system compares 20 the current travel speed (St) to the sum of the reference speed (Sr) and the upper deviation value (Du). Since the travel speed, 44 m.p.h., does not exceed the sum of the reference speed, 40 m.p.h., and the upper deviation value, 5 m.p.h., the system makes a second comparison 40, between the travel speed (St) and the difference between the reference speed (Sr) and the lower deviation value (Dl). A current travel speed, 44 m.p.h., which is not less than the difference between the reference speed, 40 m.p.h., and the deviation value 5 m.p.h., implies the travel speed falls within the “mid speed” range. The system makes the hystereses evaluation 25 by querying the output color status. Since the display has previously adopted an “over speed” color status, the system evaluates 30 if the “mid speed” value falls within the hystereses value (H). In our example, since the display has adopted a red color, the system evaluates if the travel speed, 44 m.p.h., falls within the upper hystereses range of 43-45 m.p.h. Since 44 m.p.h. falls within that range, the system continues to display “over speed” color status, red. The system then receives 15 a new travel speed (St) and repeats the comparison functions.

The parallel process occurs for travel speeds falling below the difference between the reference speed (Sr) and the lower deviation (Dl), or falling within the lower hystereses (H) range.

It will be appreciated that the above descriptions are intended only to serve as examples, and that many other embodiments are possible.

### Another Description of the Low-Speed, Mid-Speed, and High Speed Ranges; A Description of “Transition Speeds”

In the example of FIG. 2A, there is no hystersis, and the vehicle state (i.e. which is categorized as ‘low-speed’/‘under-speed’ 45, ‘mid-speed 10, or ‘over-speed’/‘high-speed’/‘fast-speed’ 30) depends only on the current ‘subsequent speed’ (i.e. subsequent to setting the reference speed) of the motor vehicle. In the example of FIG. 2A, there is no need to consider ‘historical subsequent speeds’ of the motor vehicle.

FIG. 2C illustrate a ‘speed line’ of the subsequent speed, which is divided into three regions: a ‘low-speed’ or ‘under-speed’ region 270 (see step 45 of FIG. 2A), a ‘mid-speed’ region 280 (see step 10 of FIG. 2A), and a ‘fast-speed’ or ‘high speed’ or ‘over-speed’ region 290 (see step 30 of FIG. 2A).

In the example of FIG. 2C, the “mid-fast transition speed” 296 (i.e. the speed that the motor vehicle must exceed in order to transition from the ‘mid-speed’ state to the “high-speed”/“fast-speed/“over-speed” state) is equal to the “fast-mid transition speed’ 298 (i.e. the speed that the motor vehicle must drop below in order to transition from the “high-speed”/“fast-speed/“over-speed” state to the ‘mid-speed’ state). Similarly, the “slow-mid transition speed” 292 (i.e. the speed that the motor vehicle must exceed in order to transition from the ‘slow-speed’/‘under-speed’ state to the ‘mid speed state’ is equal to the “mid-slow transition speed” 294 (i.e. the speed that the motor vehicle must drop below in order to transition from the “high-speed”/“fast-speed/“over-speed” state to the ‘mid-speed’ state).

This is not the case in FIG. 2D, which relates to the case of hysteris. In this case, once the vehicle accelerates to transitions from the ‘slow-speed state’ to the mid-speed state’ (i.e. by exceeding the ‘slow-mid transition speed 292), even if the speed drops down “a little” (i.e. by less than H), and the vehicle speed is in region 284, the vehicle is still considered to be in the “mid-speed state,” for example, in order to prevent quickly “flickering” between speed states. In this case, the vehicle speed must then drop below the ‘mid-slow transition speed’ 294 in order for the vehicle to transition to the ‘under’ or ‘slow’ state. In this case, the “history” of the vehicle speed determine if the vehicle is in the ‘under/slow’ state of the ‘mid’ state.

Similarly, once the vehicle accelerates to transitions from the ‘mid-speed state’ to the ‘high or fast or over-speed state’ (i.e. by exceeding the ‘mid-fast transition speed 296), even if the speed drops down “a little” (i.e. by less than H), and the vehicle speed is in region 288, the vehicle is still considered to be in the “high/over/fast speed state,” for example, in order to prevent quickly “flickering” between speed states. In this case, the vehicle speed must then drop below the ‘fast-mid transition speed’ 288 in order for the vehicle to transition to the ‘under’ or ‘slow’ state. In this case, the “history” of the vehicle speed determine if the vehicle is in the ‘over/fast/hight’ state of the ‘mid’ state.

In the example of FIG. 2D, the hystersis values used at the “slow-mid” and the “mid-fast” borders are equal (i.e. the size of regions 284 and 288 are equal), though this is not at all a limitation.

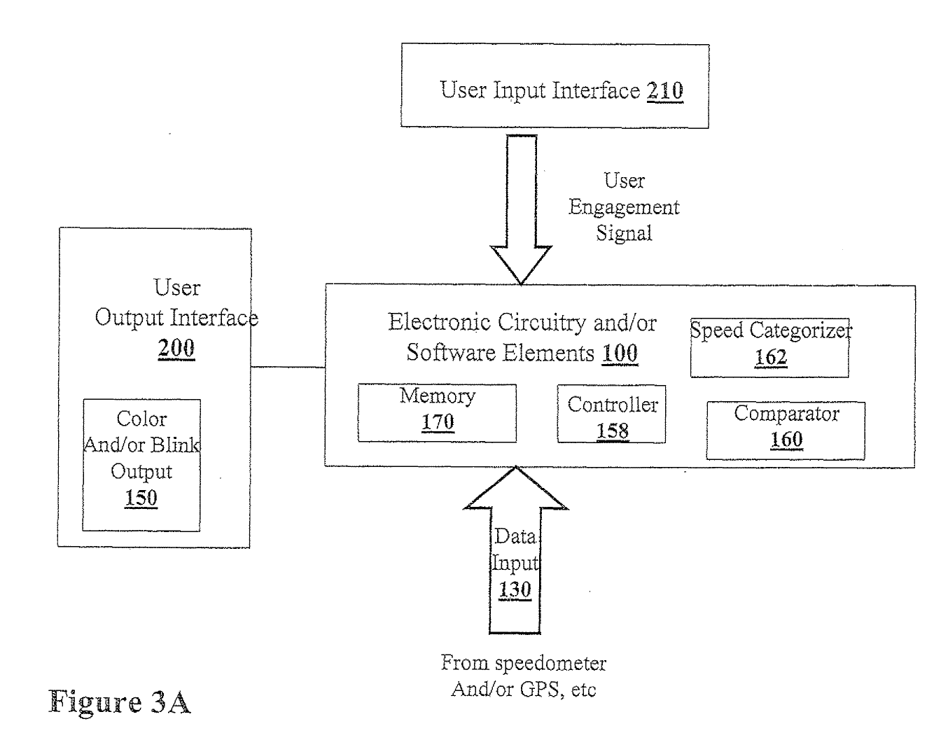

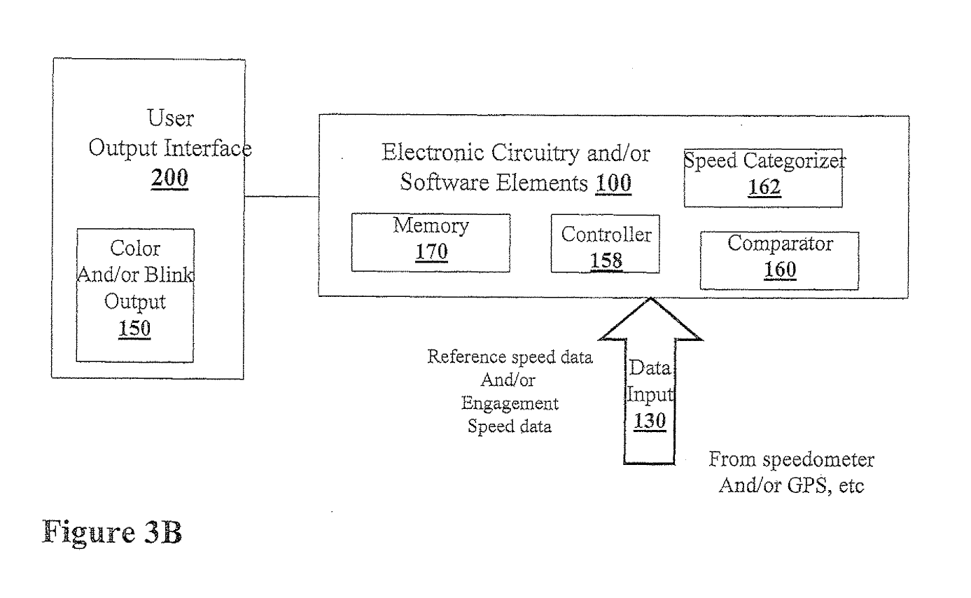

FIG. 3A provides a block diagram of an apparatus for displaying speed deviation information indication in accordance with some embodiments of the present invention. According to the example of FIG. 3A, the apparatus includes (i) a data input 130 for providing receiving a prevailing or current speed of the motor vehicle (for example, from a speedometer), (ii) a user input interface 210, enabling the user to establish a reference speed, (iii) a user output 200 providing the user with color and/or blink signal depicting the deviation from the reference speed, and (iii) electronic circuitry and/or software elements 100 for comparing the input speed with the reference value and sending the appropriate signal to the color or blink output 150.

In the example of FIG. 3, the speed comparator 160 (i.e. for comparing speed) and the speed categorizer 162 (i.e. for determining if the vehicle is in a slow/under, mid, or high/fast/over speed state) are also illustrated.

In the non-limiting example of FIG. 3, electronic circuitry 100 includes memory 170 (i.e. volatile and/or non-volatile) for recording (i) the reference or setpoint speed Sr received from speedometer 130 (i.e. at a time that a signal is received from user input interface 210 that the user has engaged the user input interface 210 to “set” the reference speed—this may be determined be controller 158 which may be implemented as any combination of software and/or hardware; and (ii) a subsequent speed St of the motor vehicle received from the speedometer 130. In one non-limiting example, the subsequent speed is monitored and recorded at a certain time frequency, for example, once every second.

Thus, in the example of FIG. 3A, it may be said that electronic circuitry 100 is configured as a “speed recorder.”

In one non-limiting example deviation values (Dₗ & Dᵤ), tolerance values and/or hystereses (H) values are stored in volatile and/or non-volatile memory 170.

In one example, the non-volatile memory is a type of electronic circuitry, for example, flash memory. Alternatively or additionally, magnetic media (not shown) may be used to store any values.

It is noted that the comparator and/or any electronic control may be implemented in any combination of hardware and software.

FIG. 3B describes an alternative implementation. In this embodiment, instead of the controller 158 determining the reference speed according to a detected engagement of the user interface, the reference speed is received via data input 130—for example, a wireless input for remotely receiving data and/or a local input for receiving data from ‘on-board’ electronic elements. In one non-limiting example, the reference speed is received directly or indirectly from a sensor—for example, a sensor which senses local weather conditions. In another non-limiting example, the reference speed is receive from any type of electronic device—for example, a device which broadcasts the local speed limit.

The user output interface of the present invention, which may present, in the driver cone of sight, the visual signal(s) indicating speed deviation, if any, by the motor vehicle, may have a minimum light intensity. The apparatus and method of the present invention is designed to enable the driver to notice the changes in visual signals of the user output interface or speed deviation indicator 200 without necessarily having to look at the source of light providing the visual signal. This allows the driver to focus on the road. Based on experimentation, in order for the driver, during bright daylight, to notice the visual signals and the changes in visual signals used in accordance with the embodiments of the present invention, when not looking at the source of light, it may not be enough that the source of light is located in the cone of sight of the driver. Rather, the luminous intensity of the light may necessarily have to be set at 2000 mcd or minicandles or more during bright daylight. Since 2000 mcd is sufficient for bright daylight, moreover, 2000 mcd is certainly also sufficient for nighttime or cloudy days, when the intensity of ambient light is even less than during bright daylight.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise. The term “such as” is used herein to mean, and is used interchangeably, with the phrase “such as but not limited to”.

The present invention has been described using detailed descriptions of embodiments hereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A speed deviation indication apparatus for use in a motor vehicle, the apparatus comprising:
a) a data input for receiving a description of a prevailing speed of the motor vehicle;
b) an electronic memory for storing a non-zero reference speed \and
c) a user output interface operative to present, in a driver cone of sight defined by the motor vehicle, a visual signal of an intensity of at least 2000 minicandles indicating a speed difference between:
i) a subsequent speed of the motor vehicle as received via said data input; and
ii) said established non-zero reference speed.

2) The speed deviation indication apparatus of claim 1 further comprising:
d) a user input interface; and
e) a controller operative to establish in accordance with a detected user engagement of said user input interface, said non-zero reference speed in accordance with a prevailing said received speed at or near a time of said user engagement.

3) The speed deviation indication apparatus of claim 1 wherein said data input is operative to further receive a description of said non-zero reference speed.

4) The speed deviation indicator of claim 1 wherein:
i) the speed deviation indicator further comprises:
c) a speed categorizer, operative to categorize said subsequent speed of the motor vehicle as being in one of slow speed range, a mid speed range, and fast speed range in accordance with said speed difference between said subsequent speed and said non-zero reference speed;
ii) said user output interface is operative to provide:
A) a first visual signal state presented in said driver cone of sight, when said subsequent speed is categorized in said slow speed range;
B) a second visual signal state different from said first signal state, presented in said driver cone of sight, when said subsequent speed is categorized in said mid speed range; and
C) a third visual signal state different from said first and second visual signal states, presented in said driver cone of sight, when said subsequent speed is categorized in said fast speed range;
iii) said speed categorizer is operative to:
i) decide if said subsequent speed is categorizable as in said slow speed range or in said mid speed range in accordance with a difference between said non-zero reference speed and a first non-zero tolerance; and
ii) decide if said subsequent speed is categorizable as in said mid speed range or in said fast speed range in accordance with a sum of said non-zero reference speed and a second non-zero tolerance.

5) The speed deviation indicator of claim 4 wherein user output interface is operative such that said providing of said first, second and third visual signal states include:
i) providing, in said driver cone of sight, a first color signal for said first visual signal when said subsequent speed is categorized in said slow speed range;
ii) providing, in said driver cone of sight, a second color signal different from said first color signal for said second visual signal when said subsequent speed is categorized in said mid-speed range; and
iii) providing, in said driver cone of sight, a third color signal different from said first and second color signals for said third visual signal when said when said subsequent speed is categorized in said fast-speed range.

6) The speed deviation indicator of claim 4, wherein in order to reduce flickering after a subsequent speed has been categorized the speed categorizer sets a new transition speed between slow speed range and mid speed range and/or between mid speed range and fast speed range.

7) The speed deviation indicator of claim 4, wherein after a subsequent speed has been categorized as in the fast speed range, the speed categorizer lowers a transition speed between fast speed range and mid speed range.

8) A method of manufacturing comprising:
a) deploying in a motor vehicle:
i) a data input for receiving a description of a prevailing speed of the motor vehicle;
ii) a user input interface for establishing, in accordance with a user engagement of said user input interface, a non-zero reference speed determined by a prevailing said received prevailing speed at or near a time of said user engagement; and
ii) a user output interface operative to present, in a driver cone of sight defined by the motor vehicle, a visual signal of intensity of at least 2000 minicandles indicating a speed difference between:
A) a subsequent speed of the motor vehicle as received via said data input; and
B) said established non-zero reference speed.

9) A method of signaling motor vehicle speed deviation, the method comprising:
a) establishing a non-zero reference speed;
b) receiving a description of a prevailing speed of a motor vehicle; and
c) presenting, in a driver cone of sight defined by said motor vehicle, a visual signal of an intensity of at least 2000 minicandles indicating a speed difference between:
i) a subsequent speed of said motor vehicle as received via said data input; and
ii) said established non-zero reference speed.

10) The method of claim 9 wherein said establishing of said non-zero reference speed is carried out:
i) in response to a detected user engagement of a user input interface;
ii) in accordance with a prevailing said speed of the motor vehicle at or near a time of said user engagement.

11) The method of claim 9 wherein said establishing of said non-zero reference speed is carried out in accordance with non-user data.

12) The method of claim 9 wherein said establishing of said non-zero reference speed is carried out in accordance with a communication received wirelessly.

13) The method of claim 9 wherein said visual signal is not a numerical signal whose displayed numbers vary according to said subsequent speed.

14) The method of claim 9 wherein said visual signal is not a textual signal whose displayed text characters vary according to said subsequent speed.

15) The method of claim 9 further comprising:
d) categorizing said subsequent speed of the motor vehicle as being in one of slow speed range, a mid speed range, and fast speed range in accordance with said speed difference between said subsequent speed and said non-zero reference speed;
wherein
i) said presenting of said visual signal includes providing:
A) a first visual signal state presented in said driver cone of sight, when said subsequent speed is categorized in said slow speed range;
B) a second visual signal state different from said first signal state, presented in said driver cone of sight, when said subsequent speed is categorized in said mid speed range; and
C) a third visual signal state different from said first and second visual signal states, presented in said driver cone of sight, when said subsequent speed is categorized in said fast speed range; and
iii) said categorizing of said subsequent speed includes:
A) deciding if said subsequent speed is categorizable as in said slow speed range or in said mid speed range in accordance with a difference between said non-zero reference speed and a first non-zero tolerance; and
B) deciding if said subsequent speed is categorizable as in said mid speed range or in said fast speed range in accordance with a sum of said non-zero reference speed and a second non-zero tolerance.

16) The method of claim 15 wherein said categorizing of said subsequent speed of the motor vehicle is carried out in accordance with both a current value and one or more historical values of said difference between said subsequent speed and said established non-zero reference speed.

17) The method of claim 15 wherein said categorizing of said subsequent speed of the motor vehicle is carried out in accordance with both:
i) a current value of said difference;
ii) a most recent speed transition type.

18) The method of claim 15 said providing of said first, second and third visual states includes:
i) providing, in said driver cone of sight, a first color signal for said first visual signal when said subsequent speed is categorized in said slow speed range;
ii) providing, in said driver cone of sight, a second color signal different from said first color signal for said second visual signal when said subsequent speed is categorized in said mid-speed range; and
iv) providing, in said driver cone of sight, a third color signal different from said first and second color signals for said third visual signal when said when said subsequent speed is categorized in said fast-speed range.

19) The method of claim 9, wherein the visual signals indicate which of three speed ranges the driver is driving in.

20) The method of claim 19, wherein the three speed ranges include a speed range that is too fast and a speed range that is too slow.
